(19) United States
(12) Patent Application Publication
(10) Pub. No.: US 2010/0088586 A1
(43) Pub. Date: Apr. 8, 2010

(54) METHOD AND SYSTEM OF PRODUCTION AND/OR AUTOMATIC CONVERSION FROM HETEROGENEOUS CONTENT OF AT LEAST ONE PAGE MAKE-UP FOR ACHIEVING THE FASTEST READ WITH MAXIMUM RETENTION

(75) Inventor: Denis Roudot, Strasbourg (FR)

Correspondence Address: YOUNG & THOMPSON, 209 Madison Street, Suite 500, Alexandria, VA, 22314, US

(73) Assignee: ANDROMAQUE PREPRESSE ( Societe a Responsavilite Li, Strasbourg (FR)

(21) Appl. No.: 12/375,104

(22) PCT Filed: Jul. 25, 2007
(86) PCT No.: PCT/FR07/51726

§ 371 Date: Nov. 9, 2009

Related U.S. Application Data
(60) Provisional application No. 60/832,967, filed on Jul. 25, 2006.

(51) Int. Cl. G06F 17/00

(52) U.S. Cl. 715/229; 715/243

(57) ABSTRACT

A method and system of automatic production from heterogeneous content assembles text, table and/or image information content, at least one visual composition of page(s) for faster reading with maximum retention, in particular for a reader or user or a specific group of readers or users. The method includes: a) defining content of the blocks, from data input or recovered from existing sources; b) applying selective filtering rules to the different proposed presentations for the content in the blocks; c) generating and first selecting forms for the different blocks retained after step b); d) applying selective filtering rules to the different propositions of forms of blocks furnished in step c); e) generating and first selecting positioning for the different blocks retained after step d); f) applying selective filtering rules to the different propositions or page make-up versions furnished in step e); g) presenting a version or proposition of formatted page(s) mockup.

This invention relates to the field of formatting or composition of paper or electronic documents that are formed by at least one page, from heterogeneous contents in the form of contents that are obtained from creation and from existing contents that are recovered, whereby these heterogeneous contents can be either text, image or table components or already composed pages or a combination of components and pages.

Currently, the layout operation of a document generally consists in a basic manner in integrating the contents in a defined template for a given content form.

This drawn-out operation can be entrusted to highly-specialized personnel when it is a matter of obtaining a more elaborate layout and of manually shaping the contents with a greater flexibility/adaptability so as to achieve a high read quality or to be carried out by means of templates or preestablished matrices, in a limited number, whereby the latter are supplied manually or by programming.

Nevertheless, the results often are not optimally suited to the reader in terms of efficiency and comfort of reading, because of the distinction between the individual doing the formatting and the reader or limited options for formatting by means of imposed templates.

Actually, the formatting of the pages involves different degrees of optimization that are the result of professional know-how that stems from artistic skills: ability to manage space, rhythm, density, contrasts (in a finished space with polymorphous components), but also the conversion of the static space of the page into time since the reading of one page is not instantaneous but is the result of the eye traveling over the visible elements on the page.

The reading speed depends on the quality of form and assembly of these elements, and the ratio of elements that are perceived and not perceived, recognized and not recognized (close to recognizable models), and recorded and not recorded (ease of retention) depends on this reading speed.

In particular, this invention has as its object to provide a solution that makes it possible to automatically end in an optimized layout in terms of readability, from any contents of text, image or table type and without using imposed templates, whereby said layout is preferably personalized based on the reader or a group of readers having similar reading characteristics.

Secondly, the invention also aims at allowing, taking into account the new diversity of the existing media, the non-majority quality of the layouts available, among others, on the Internet, the bafflement of users confronted with multiple different formats when navigating among sites, the diversity of languages in which the information is available, in short, the distance that may exist between the contents and the ability of a user to integrate them, to convert these pre-laid-out contents into a new optimized presentation based on the medium on which they are displayed and read, each of these media being managed by suitable readability rules, whereby the conversion also takes into account the capabilities and interests of the receiving user. Each user should thus be able to convert all available information and to distribute it on paper, in a database or in Internet navigation in a single presentation (or several, if it is so desired) that is the most suited to it and can thus reduce the baffling diversity of the presentations that are imposed into a style that is personalized by one's efforts.

For this purpose, the invention has as its object a process for production and/or automatic conversion from complex and heterogeneous contents and by assembling blocks of information contents of the text, table and/or image type, from at least one visual composition of (a) page(s) that allow(s) the fastest read with maximum retention, in particular for a reader or user or a specific group of readers or users, a process that is characterized in that it essentially consists in carrying out successively, at the level of a computer system, the following operations or working steps for each page:

a) Definition, in particular by analysis, factorization and defactorization, of the contents of blocks, from data input by the user (dynamic creation from a database) or recovered (from data collected by automatic ingestion) from existing sources;

b) Application of programmed selective filtering rules, suitable for each type of content and, if necessary, parameterized based on the user or the group of users, with different presentations proposed for the contents in the blocks;

c) Automatic generation and first selection of forms for the different blocks adopted following step b);

d) Application of programmed selective filtering rules, and, if necessary, parameterized based on the user or the group of users, with different proposals for block forms provided in step c);

e) Automatic generation and first selection of positioning options for the different blocks that are adopted following step d);

f) Application of programmed selective filtering rules and, if necessary, parameterized based on the user or the group of users, with different layout proposals or versions provided in step e);

g) Presentation to the user or to the group of users of a formatted page mock-up version or proposal or several formatted page mock-up versions or proposals, whereby said proposals or versions are then classified according to a determined order of preference.

The invention also relates to an automatic converter for presentation of contents for the purpose of optimizing the reading speed and the assimilation of information by a specific reader or a group of readers, implementing the above-mentioned process and comprising at least one computer that is equipped with a memory, a database, an interface for communication with the user, and a means for connecting to and navigating the Worldwide Web (Internet), for example in the form of a server or an analog interface, a converter that is characterized in that it also comprises:
The different contents to be laid out, in the form of blocks and optionally combined into an article,
The rules on possible segmenting of the contents and information on possible spacing of the contents,
The information relative to the different breakdowns of the contents into upper structuring levels of the articles, for example department, family, sub-family, assortment and product, and into lower structuring levels of the contents, for example, fields, criteria and attributes,
The different rules for parameterization of applicable forms to the contents and to blocks and possible positions of the blocks,
The different rules for selecting or filtering presentations of the contents and forms and positions of the blocks,
The rules that control the travel of the eye during reading,
Information relative to the available reading time and to the centers of interest of the reader or group of readers being considered,
A system for analysis of contrasts, forms and positions of the contents,
A system for learning preferences and particular reading features of each reader or each group of readers,
A system for evaluating the reader's satisfaction of the applied parameterization and selection rules.

The system automatically converts the same content to present it in a different and optimized manner that involves: 1. A paper page, based on its size, its proportion, its orientation, . . . based on the paper quality and printing techniques used, 2. A computer screen, based on the size of the screen, its technology that influences the contrasts, display illumination, system and navigator influencing the size of the information zone, its framework, the available character fonts, system for reading these same fonts, character styles, weight, character width, available character compression, . . . , or 3. New PDA consoles (personal assistants), iPhone (registered name) or other tools that are equipped with mini-screens and new navigation processes that are derived therefrom, but also based on reading and assimilation capacities of each reader and based on:
The size of characters that he winds up reading based on the sharpness of his vision,
The types of contrasts that he winds up perceiving,
His language and his culture based on the proposed content,
His age and his subjects of interest,
His knowledge base in a field.

The invention will be better understood, using the description below, which relates to a preferred embodiment, provided by way of non-limiting example and explained with reference to the attached schematic drawings, in which:

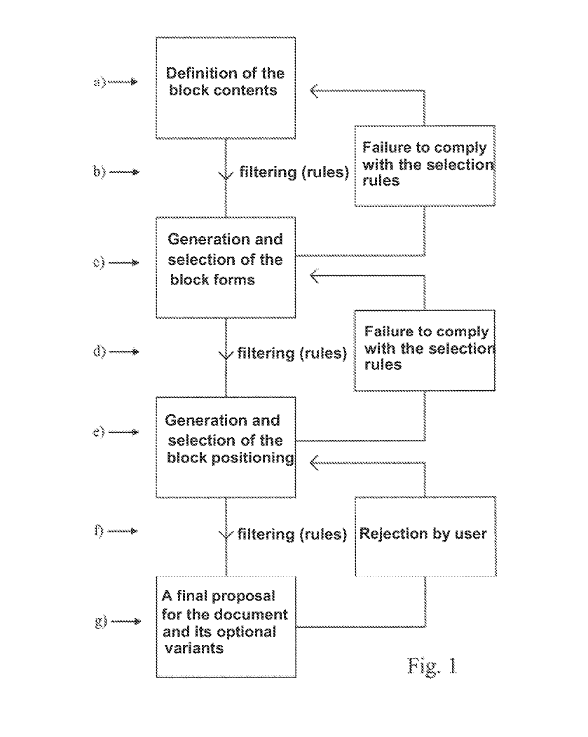

FIG. 1 is a representation in the form of a block diagram of the primary working steps of the process according to the invention;

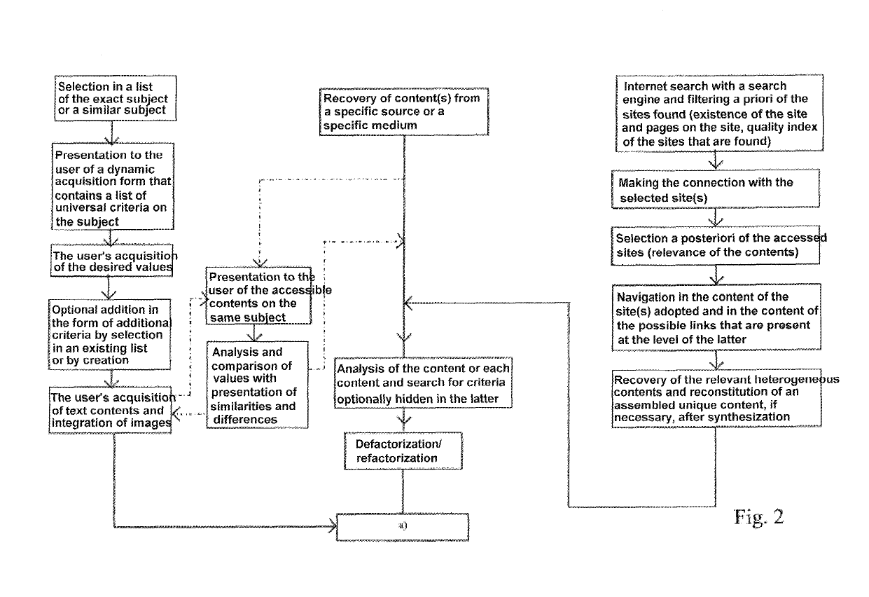

FIG. 2 is a representation in the form of a block diagram that illustrates the different options for providing contents to be assembled and laid out;

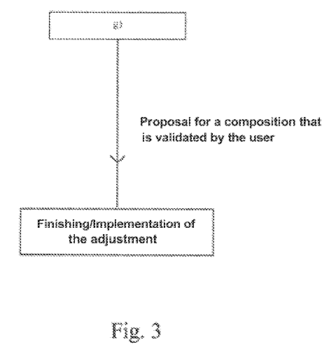

FIG. 3 is a representation in the form of a block diagram of a possible adjustment operation consecutive to the selection by the user of one of the proposals for visual lay-out compositions;

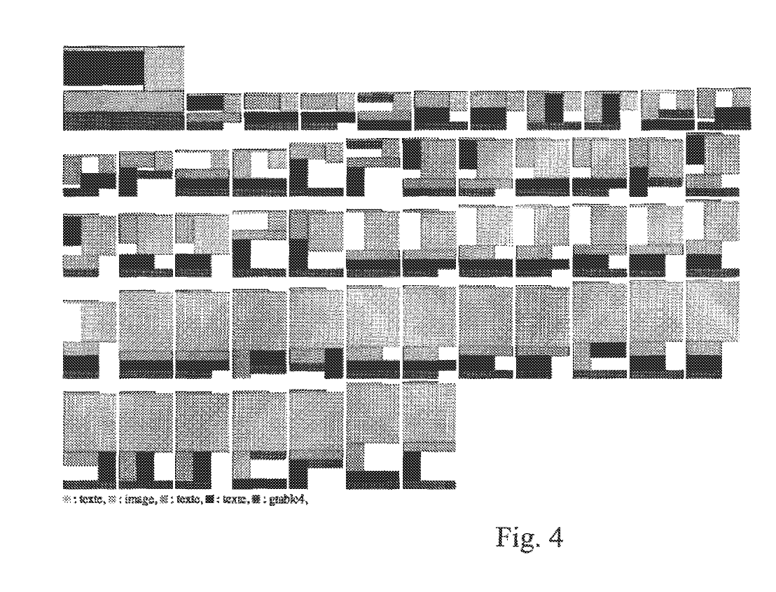

FIG. 4 is a screen print illustrating a working step of the process that is not visible to the user, for a given case, the different proposals for form and positioning of the blocks provided after the operation e) of the process shown in FIG. 1, whereby said proposals are arranged in decreasing order of preference;

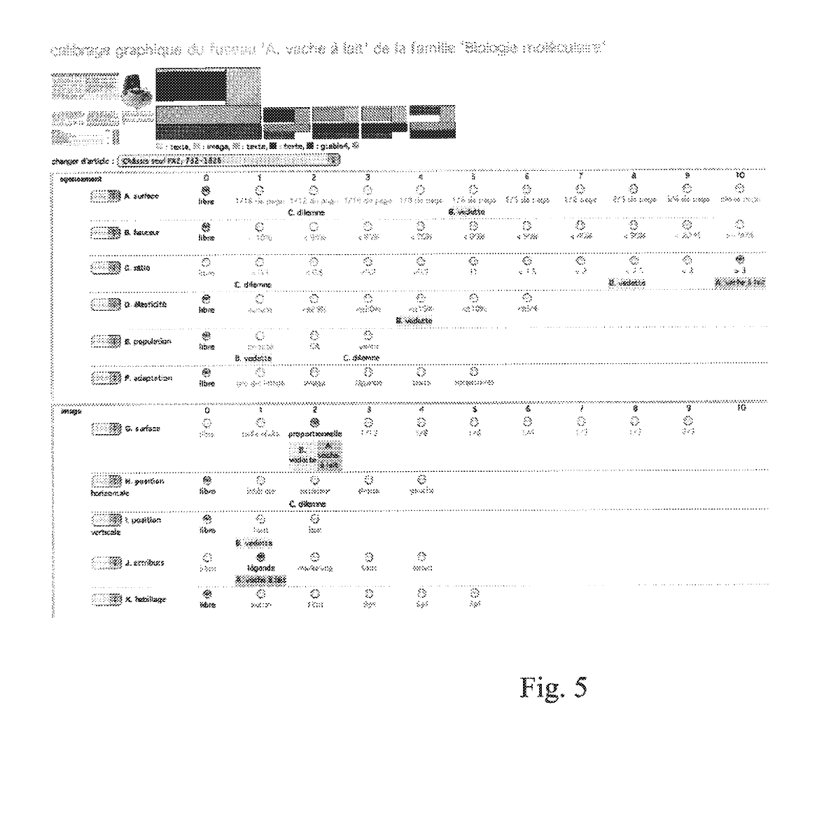

FIG. 5 is a screen print illustrating, for the case of FIG. 4, the filtered proposals presented to the user following the working step b) of the process shown in FIG. 1, and

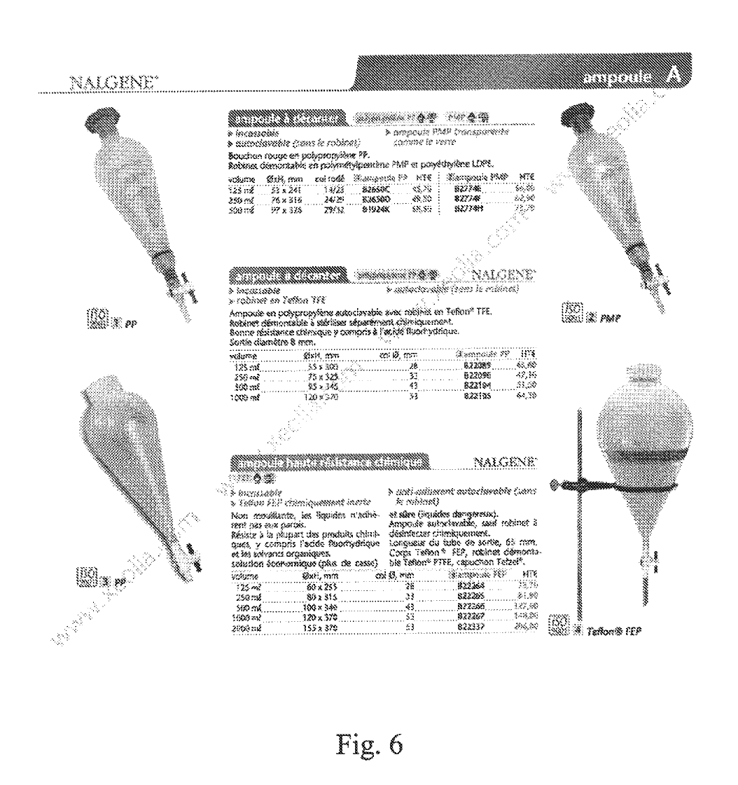

FIG. 6 is a screen print of one page of a catalogue that is developed by means of the process according to the invention.

The process according to the invention makes possible the automatic production from complex and heterogeneous contents and by assembling blocks of information content of the text, table and/or image type, at least one visual composition of page(s) making possible the fastest read with maximum retention, in particular for a reader or user or a specific group of readers or users.

This process essentially consists in carrying out successively, at the level of a computer system, the following operations or working steps, this for each page:

a) Definition, in particular by analysis, factorization and defactorization, of block contents from data input by the user or recovered from existing sources;

b) Application of programmed selective filtering rules, adapted to each type of content, and, if necessary, parameterized based on the user or group of users, to the different presentations proposed for the contents in the blocks;

c) Automatic generation and first selection of forms for the different blocks that are adopted following step b);

d) Application of programmed selective filtering rules, and, if necessary, parameterized based on the user or the group of users, to different proposals for block forms provided in step c);

e) Automatic generation and first selection of positioning options for different blocks adopted following step d);

f) Application of programmed selective filtering rules and, if necessary, parameterized based on the user or the group of users, to different layout proposals or versions provided in step e);

g) Presentation to the user or to the group of users of a formatted page mock-up version or proposal or several formatted page mock-up versions or proposals, whereby said proposals or versions are then arranged in a specified order of preference.

The process therefore makes it possible to automatically ensure, from available or created contents, the best assembly from among the multitude of options, whereby the latter best meets the perception constraints and therefore the reading speed.

The contents are generally descriptive-type information, i.e., they involve products, objects, ideas, optionally an entire set of elements that can be the object of a classification, and the blocks normally have rectangular shapes.

Thus, this automatic process eliminates the steps involved in shaping by hand or by templates or pre-established matrix, replacing it with loops for simulation and selection of formats that best comply with the rules of readability and quality of presentation stored by the computer system executing said process.

The most complex and heterogeneous forms of editorial components are taken into consideration by the system to provide compositions or mockups that do not have any space that is lost, not seen, or not wanted by the reader who does not yet know the new content and its format that he will read.

In addition to the elimination by this process of the mock-up action and all the upstream and downstream operations that this involves, the system reduces (instantaneously) the creation phase of the contents and makes the readers participate in the evaluation of the lengths and relevance of the contents.

Preferably, and as FIG. 1 shows, the successive operations a) to g) are arranged in three iterative loops for simulation and selection of the best proposals or versions of the forms of contents, forms of blocks and relative positioning options of the blocks on the page in question.

Advantageously, and so as to limit unnecessary processing, the operation a) for defining contents of blocks and the operations for first selection at steps c) and e) implement integrated parameterization rules that carry out, on the one hand, a rejection of the proposals that are not in accordance with criteria or parameters based on presentation or ending in an impossibility of presentation on the page in question, and, on the other hand, an evaluation and an arrangement of proposals that are not rejected.

According to a characteristic of the invention, the operations a) and c) are executed in a different manner based on the nature of the content of the processed blocks, namely text, image or table, and by applying a set of rules for formatting or specific parameterization respectively to each type of content, whereby the operation e) that carries out the assembly of the different blocks of a page applies a set of rules common to the three types of blocks.

Actually, for each of these different types of blocks, separate presentation parameters should be taken into account.

Thus, for the table blocks, there are a large number of parameters that fit together or follow one another to automatically construct the formatting of the tables, namely:
The meaning of the information from items contained in the table, placed in columns or in rows;
The grouping of several tables into one or vice versa;
The order of appearance of the items, based on the contents, or arrangement by hand;
The order of appearance of criteria (arrangement of contents, for example height or width), optionally based on values of the criteria that are present in the table or arrangement by hand;
The factorization or not of the criteria (the factorization makes it possible to manage the presence or not in the table of certain criteria whose values are identical for each of the articles);
The vertical, horizontal or mixed merging or otherwise of identical values when they are not factorized;
The balancing of the widths of columns and the width and height of the entire table, by taking into account surfaces of the body of the table and the headers (based on rules providing the minimum and maximum numbers of lines or columns in the body of the table and the same rules for the table header);
Application of abbreviations in the titles so as to optimize the ratio of header size and content size;
Factorization of the units in the table header so as to avoid repeating it on each line;
Alignments of the contents on separators such as comma, /, x, to . . . to the measuring units . . . .

Whereby the creation of several variants and the rules of selection make it possible to define what the best variant is to adopt, these rules take into account more or less the spacing that exists in the versions, the relative ratio between the width and the height of the tables, and other analogous considerations.

For the image blocks, the following parameters are to be taken into consideration in particular:
Position of text-type contents in the form of legends that are free or anchored to a particular point of the image;
Position of the images between one another according to the type of images;
Automatic assembly of several so-called detoured images by taking into account the shape of the detour, to find the best fitting possible while making it possible for the images to be as large as possible, or to minimize or optimize the surface area of the spaces;
Reference system between an image and data in the form of a reference number, codes, etc., generally anchored to the image.

For the text blocks, the following parameters should be taken into consideration in particular:
Succession of fields (titles, slogan, text, . . . ) in the text blocks;
Application of styles based on the contents;
Factorization of the contents that are identical to several items, products or objects so that they appear only once and management of display order so that the identical texts are recognized as being common to a series of objects.

In addition, it is advisable to note that the width of the text block is defined by the length and therefore the number of characters, the size of the characters, the distance between the letters and the lines, the overall unit constituting a typographic grayscale and a reading sequence calculated in one-thousandth of a second. The optimum width of the text can be calculated at nearly 5% and on the basis of the optimum width, variants can be calculated (reduction of the size of the character leads to the reduction of the width of the block that contains the lines . . . ). The contrasts that are necessary to the layout determine the proposals for presentation of the text that are adopted.

The optional segmenting of the texts by a user can be carried out on a selection of criteria based on the centers of interests that have been indicated.

According to two advantageous arrangements of the invention, the visible total surface area of a block or a group of blocks is determined by reporting rules between the quantity of information contained in this or these blocks and the performance level that is expected for this information, and the positioning of the blocks in step e) is governed by rules for separating and combining blocks and by rules of maximum and minimum distances between separated blocks.

In accordance with another characteristic of the invention, at least the filtering rules that are used before the operation g), preferably all of the filtering rules that are applied in the working steps b), d) and f), integrate rules that govern the travel of the human eye and the perception of contents during reading applied to the different proposals that are obtained from the preceding operation, whereby the latter are subjected in particular to an analysis of contrasts, forms and/or block positions with different contents that form each page.

In this context, the process consists in measuring and recording the values of visual density or typographic grayscale of different content blocks, such as text, table or image, in determining and recording the contrasts between the visual densities or topographical grayscale of the different blocks, and in carrying out the positioning of the blocks so as to attribute the best contrasts and the best locations to the blocks whose contents are to be shown, in particular to be seen when a reader's eye glances rapidly over the page in question.

Thus, the successive rules that are applied that make it possible to take into account the reading direction are as follows:
The typographic grayscale of each part of text, table, and image content is measured and recorded, whereby the typographic grayscale makes it possible to measure the visual density of a text, a table or an image;
The contrasts between the typographic grayscales of each part of text, table and image content are measured and recorded;
The placements or positioning of the blocks are carried out to attribute the best contrasts and to distribute the best contents to the best locations, those that the eye sees in the most rapid travel;
The conflicts between the attributions of the locations are managed, for example, by rules of preference;
Different versions are created based on the estimated time that the user announces or is estimated to have spent on a page and the number of data that it is desired be integrated.

Preferably, the selective filtering rules integrate selection criteria based on the optimum surface or size for each block, the optimum number of blocks per page, the filling rate of each page, and the number of movements of the eye to travel over each page, whereby said filtering rules are applied after each of the operations a), c) and e) or only after the operation e), whereby the proposals that are adopted after each filtering operation are protected.

According to a characteristic of the invention, the integrated rules that govern the first selections at the level of operations c) and e) and/or the filtering rules of the filtering operations b), d) and f) take into consideration information from available or estimated reading time, programmed, measured or estimated interest centers of the reader or group of readers and the quantity of information to be recorded by the reader or group of readers in the available reading time.

According to another very advantageous characteristic of the invention, the process can comprise a preliminary phase for learning preferences and special reading features of each reader or group of readers, for example by display of several compositions for testing and aquiring and translating comments and/or selections of the user or the group of users in question, in the form of preferences in terms of values or ranges of values of density, contrast, arrangement, size and chrominance by said reader or group.

Likewise, provision can be made for adjusting the selective filtering rules of the working steps b), d) and f) based on the degree of satisfaction of the reader or group of readers with the proposal(s) for mock-up of formatted page(s) and, if necessary, the arrangement of the latter, at the end of the operation g), whereby said adjustment is preferably carried out automatically by an evaluation of the proposal(s) accepted and/or rejected by the reader or group of readers and resulting in a variation of the gradation and/or the importance of each of the selective filtering rules that are applied.

So as to limit the time of execution of the process, provision can be made so that the data processing for executing operations a) to g) is carried out in parallel by distribution of the computation loads over several computer units that are connected to one another, locally or in a network.

The contents that have to be laid out by the process may have different origins. Thus, these contents can result from operations for creation by one or more user(s), a recovery from existing media or sources (databases, diskettes, compact disks, . . . ) or a recovery by means of the Worldwide Web (Internet).

Thus, when the contents of at least certain text and/or table blocks are entered manually, one or more dynamic acquisition form(s) containing the criteria selected for the subject is (are) proposed to the user, author of the content on the subject, whereby the accessible existing contents relate to the subject that is processed by the user and the similarities and differences detected after analysis and comparison are presented to the user upon request.

During the creation of the content, the process makes it possible via, for example, an Internet site, to edit, correct, select the information in a network with several users in parallel, whereby each of their inputs is traced and can be filtered, validated or canceled by other authorized users (having authorization).

Furthermore, when the contents of at least certain blocks are imported or recovered from an outside source, there is carried out, on the one hand, an automatic detection of the type of content, its structure, its breakdown, and links between the possible pages, and, on the other hand, a new presentation of said contents according to a preliminary parameterization, imposed standard, or, depending on the reader, based on the degree of preservation of the original presentation and a possible processing of the information that is the subject of the content, for example by factorization, translation, categorization or synthesization.

According to a first variant, during the recovery of content(s) from an outside source or a specific medium, it consists in carrying out an analysis of each content and its presentation, in seeking criteria possibly hidden in this content, and in applying defactorization and factorization operations to this content, before defining one or more proposals for presentation of said content, whereby the accessible existing contents relate to the subject processed by the user and the similarities and differences detected after analysis and comparison are presented to the user upon request.

According to a second variant, during the recovery of contents from the Internet sites, it consists in carrying out a search using a search engine that is parameterized based on the desired content, in carrying out a filtering a priori of the sites that are found, for example, based on the effective existence of the site, the date of its last update, its structuring and/or its quality index, in making the connection with the selected site(s), in carrying out a second selection a posteriori of the accessed sites, for example based on the relevance or the richness of the contents, in navigating in the site(s) adopted and in the possible links that are present at the page level of said site(s), in recovering the relevant heterogeneous contents, in reconstituting an assembled unique content, optionally synthesized, in analyzing the resulting content and in seeking the hidden criteria and ultimately in defactorizing and in factorizing said content.

The process also carries out a reduction in perceptible visual noise in the media including the Internet sites optionally by eliminating the advertisements or certain zones or links that are not directly related to the desired subject: legal notes, boxes, various lists . . . .

The detail of the operations that are carried out during the creation or the recovery of contents by the user is evident from FIG. 2 of the drawings.

Thus, the process proposes, regardless of the subject of the content that is recovered or to be created, a mask or dynamic acquisition form to the user to guide him in the development of the content relative to the subject in question.

The form is the most relevant possible: it is automatically constructed by selection of criteria from among the known universal criteria (known because they are accumulated from the latest requests and by an analysis of criteria that are used on the sites that deal with the subject) on all of the existing subjects.

The criteria are selected by analysis of contents with existing identical or similar criteria on the sites or sources so as to constitute the list of these criteria for the subject that is desired by the user.

In addition, an order of presentation of these criteria and their degree of importance is defined.

According to the selection of the user or his profile, all or part of the criteria is consecutively displayed, and the user can increase or reduce the number of displayed criteria.

In addition, as the users consume or do not consume the criteria proposed for the acquisition, the selection of criteria is automatically readjusted.

The factorization makes it possible to manage the presence or not in the table of certain criteria whose values are identical for each of the articles. The invention distinguishes between the factorization of criteria, which consists in concatenating—at the level of the display—several criteria into a single criterion (for example the 3 criteria of length, depth and width into a single criterion containing the three preceding ones, namely length×depth×height or else LPH=a single criterion with, for example, a value for an article of 100×150×60), and the factorization of values, which makes it possible to extract a common value with several articles, for example, of a table so as to exhibit it only once at another location of the editing.

The possible segmenting of texts by a user can be carried out on a selection of criteria based on centers of interest that have been indicated. They can also come from more global filters such as parental filters or the like.

In the case of large populations of objects to depict, the recovery or the automatic creation of a structure with several stages (tree structure) is provided that makes it possible to put objects having a certain number of common characteristics into larger and larger groups as the number of common characteristics decreases.

A grouping of criteria (height, width, strength, color, . . . ) among them (size, electrical, optical, . . . ) can also be provided within the framework of the process. Based on their very large number, there is a grouping of these criteria so as to make it possible to present them contextually to an author of new content.

So as to optimize the presentation of the final proposal selected, provision can be made for carrying out, as FIG. 3 shows, one or more operations for adjusting the visual composition proposal that is ultimately adopted by the user following operation g).

The adjustment is automatically activated in certain cases either to return a little more content in the page, or to better balance the content and the spaces: when, in a particular layout, it is desired to return a limited amount of extra text, one more image, . . . in summary when the page would be more complete by returning more content and it is suitable to slightly reduce the size of the current blocks or in the opposite case when a page contains one or more small spaces that it is more advisable to fill by slightly increasing the size of the blocks that are contained on the page.

The adjustment consists in carrying out the following consecutive operations:
Automatic detection of the cases where it is necessary to involve the adjuster (detection of spaces that are too large between the blocks or detection of a small overflow),
Automatic selection of the best result of a coupling of two parameters:
   1. Combination of different adjustment criteria, and 2. Blocks on which the combination of criterion types takes place,
Filtering of the results to adopt the best pairs, the best pairs being those that produce a result that is invisible or almost invisible for a reader, i.e., that lead to producing the adjustment result (to reduce or increase the block size) by intervening as little as possible on the typographic grayscale, i.e., on the visual execution of the texts displayed for the readers.

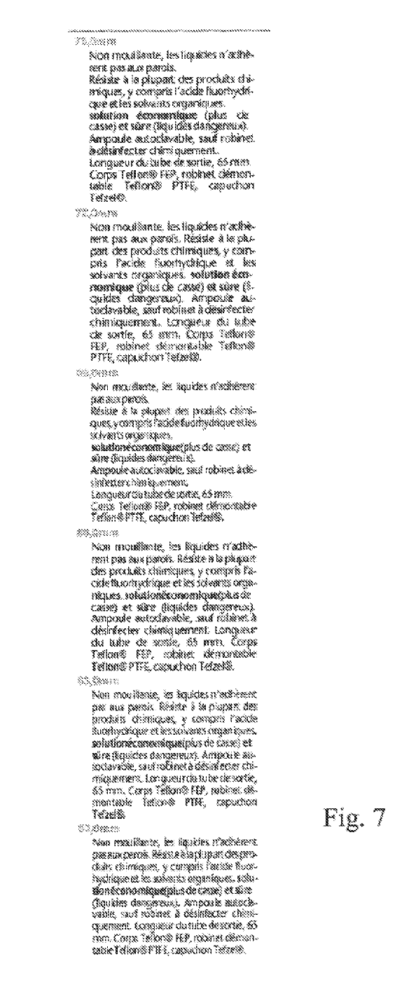

FIG. 7 shows an example of a reduction in size of the content of a block so as to reduce its height.

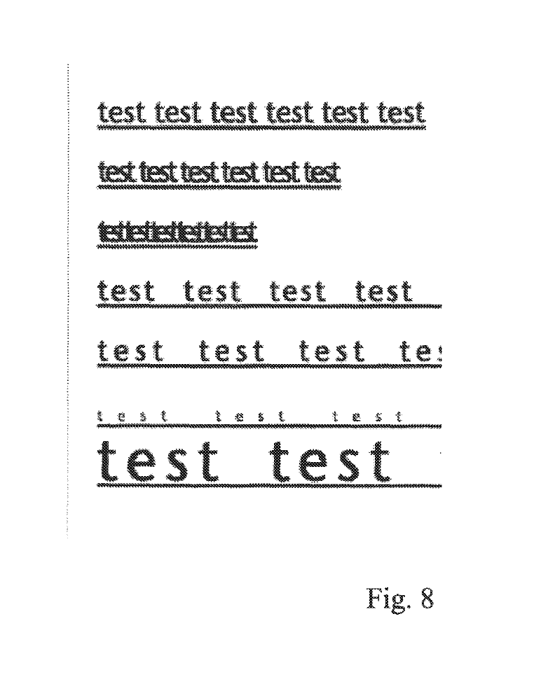

FIG. 8 shows examples of criteria in which it is possible to provide input to modify the length of a line of characters.

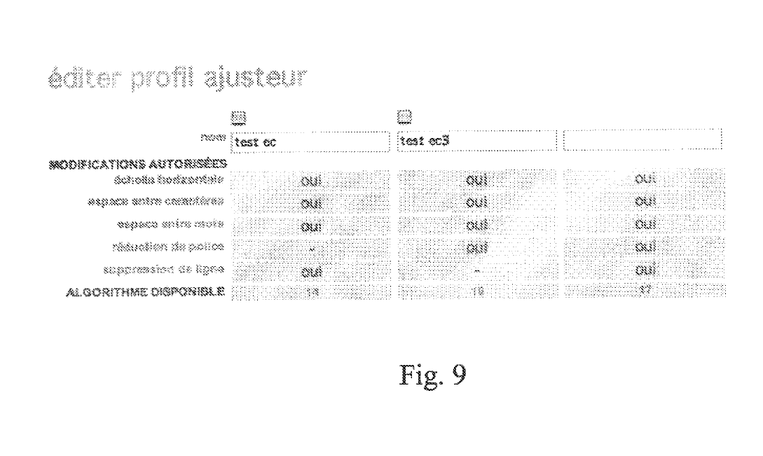

FIG. 9 illustrates an example of authorized input criteria to modify the size: eliminate (or add) spaces between paragraphs, eliminate (or add) line feeds, eliminate (or add) spaces between words, spaces between letters, reduce or increase the width of each character, and reduce or increase the size (font) of each character.

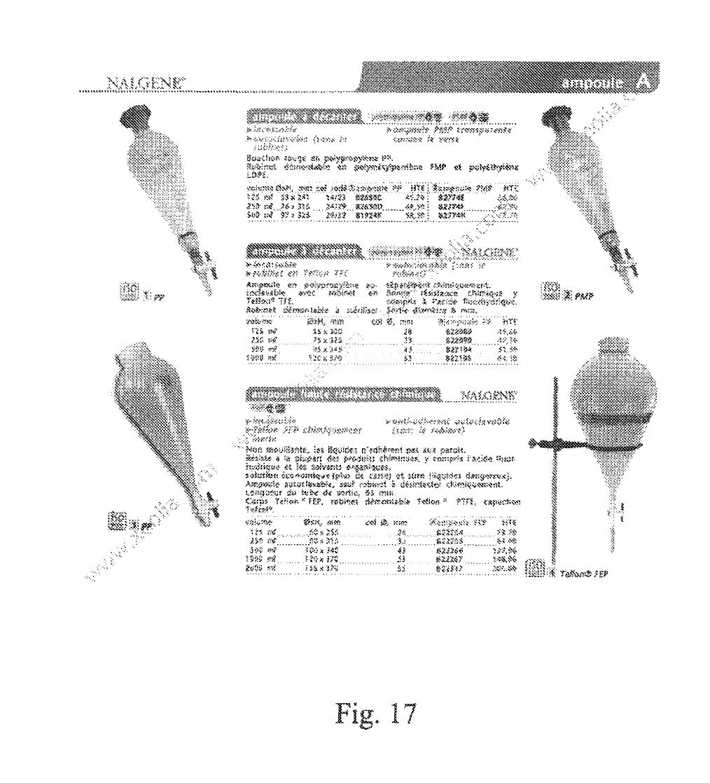

FIG. 17 is a view of the same page as that of FIG. 6 after the passage of the automatic adjuster of which the effect here will be to reduce the spaces between the blocks by lengthening the texts contained in each of the blocks.

The process thus makes it possible to recover contents in layouts, to translate them, and to restore them in the same layout. In this case, the adjustment operation makes it possible to adjust or to adapt the translated content of each block to the initial size of the block.

To carry out the translations, the process advantageously seeks, in dictionaries contained in the system or in on-line dictionaries, the most relevant translations based on the analysis of the themes that are found in the texts (words that have a theme that is linked to the economy, mechanics, architecture, . . . ). For this purpose, the system consults and analyzes the theme of each word of the content. It thus avoids the pitfall of poorly translated homonyms (example, “argent” translated into English by “silver” instead of “money”). The system exhibits on the Internet (or on another network) the translated phrases to an authorized validator by displaying the texts that are translated beside the source texts, by using colors (or other visual means) to alert him to a relevance level that is calculated from the translation (isolated words have a better relevance level than the complex phrases; the phrases already validated by another validator have a maximum relevance level, etc.). The system accumulates all of the validations produced on all of the lines of characters of all of the contents. So as to optimize the translation times, if the validator carries out a correction of at least one word in a phrase, the system exhibits all of the phrases that contain the modified sequence and then proposes to the validator the automatic taking into account of his modification on all or part of these phrases that contain the same sequence. A major advantage of the system is to accumulate and to use as a priority all of the translation sequences that are manually validated by authorized users; the system thus is distinguished from robots that produce the same translation errors indefinitely.

In the case of a diffusion on paper and a translation of the contents into several languages, this process makes possible the overprinting of all or parts of the texts in one color without affecting the other colors that are used by the printer; in this case, the system takes into account the longest language when reserving block spaces and uses the adjustment operation to adjust the content of each language to the size of the blocks that are thus calculated and reserved for the longest translation.

This invention also has as its object a system for the implementation of the process that is described above, in the form of an automatic converter for presenting contents with optimization of the reading speed and the assimilation of the information by a reader or a specific group of readers (FIG. 3).

This system essentially consists of:
A computer system that consists of at least one computer, a database, an Internet server, an Internet network;
Different contents grouped into articles;
Information on the breakdowns of possible contents (to obtain different lengths of contents—the cut-out of contents can be carried out relative to criteria that are taken into consideration, by segmenting rules of certain criteria);
Different breakdowns of the content into upper structuring levels of the articles (department, family, sub-family, assortment, product) and lower structuring levels of the content (fields, criteria, attributes);
Different rules for parameterization of the forms that are applicable to the contents and to the positions of the contents (for example: title at the top or covering the columns, title in large characters, images above titles that are rather presented on the right in the case of an isolated page or on the outside in the case of a double page);
Different rules for selecting forms and positions of the contents (for example, space rule: produce the least space possible, or the smallest number of spaces or the most harmonious form of space, or the space best used or a combination of these parameters);
The rules that govern the travel of the eye during reading (point where the eye enters the page at the point of greater contrast closest to the central zone then movement of the eye to the most accessible contrast point No. 2, and so on. It involves an algorithm that reproduces the movement of the eye and that adapts the contrast, size and position of the blocks based on this travel, reducing the body or the typographic grayscale of the texts, the size or the contrast of the images, consequently, and possibility of reducing the length of the content by adding a link to read the continuation);
A system for analysis of the contrasts of the forms and position of the contents and other characteristics that determine the travel of the eye and the perception of the contents;
Information on available reading time and centers of interest of the reader (supplied by a tool for testing and learning by the system, parameterization of the system in the absence of the user);
A system for learning preferences and special reading features by the reader;
A system for satisfying the reader with the rules applied by the system;
A system for distributing the computation loads over several computers locally or in a network makes it possible to accelerate the times of calculation so as to carry out the simulations and the selections of simulations in fractions of seconds.

The rules that govern the travel of the eye during the reading constitute a simulator of movements of the eye with a breakdown of the number of movements, the time spent at each stopping point based on the number of data found therein and that can be grasped in a single time or shunted a single time (a homogeneous descriptive text, for example).

By way of examples of lower structuring levels of the content of the type [field, criteria, attribute], it is possible to cite: outside length=‘size’ field, ‘length’ criterion, ‘outside’ criterion; within ‘dimension’ field, there is ‘height, width, . . . , ’ and in the criteria, there are ‘maximum, minimum, inside, outside, recommended . . . ’.

In addition, the process can implement the syntax of complex criteria (lower structuring levels of the content) by combining criteria.

The number of criteria is 15 (including the criterion):

### Subject

1. Criterion: Primary wording, the smallest common denominator, answers the question ‘what?’
2. Position: Spatial characteristic (top, bottom, upper, . . . ) or positional characteristic, answers the question ‘which?’
3. Attribute: Attribute of the criterion, a state, standard, recommendation, . . . answers the question ‘how?’ (absorbed, recommended, consumed, . . . )
4. Scale: Provides a relative or absolute size indication, a scale of magnitude: ‘maximum, total, optimum, . . . )

### Object

5. Number: Answers the question ‘how many objects?’ (1, 2, 3, . . . )
6. Component: Answers the question ‘from what?’ or ‘on what’? (hole, objective)
7. Position: Same as 2, applied to the object
8. Attribute: Same as 3 applied to the object
9. Scale: Same as 4 applied to the object

### Context

10. Condition: in what context of time, space or environment (at 15° C., in 30 seconds, . . . )
11. Model: On what model of objects in particular (on the hole model, . . . )
12. Tolerance: Indication of tolerance: ±5%
13. Unit: System of universal units (m, mm, kg, min, . . . )

### Other

14. Boolean: Corresponds to ‘false criteria’ whose value is yes-no, with-without, . . . or another Boolean.

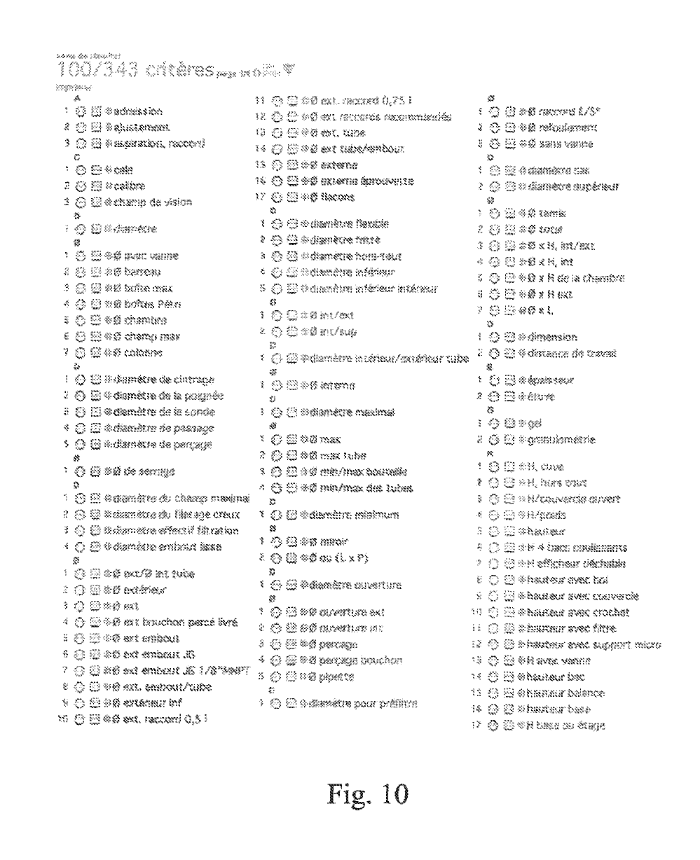

FIG. 10 shows a screen that shows a list of criteria that are detected automatically in the contents of a site.

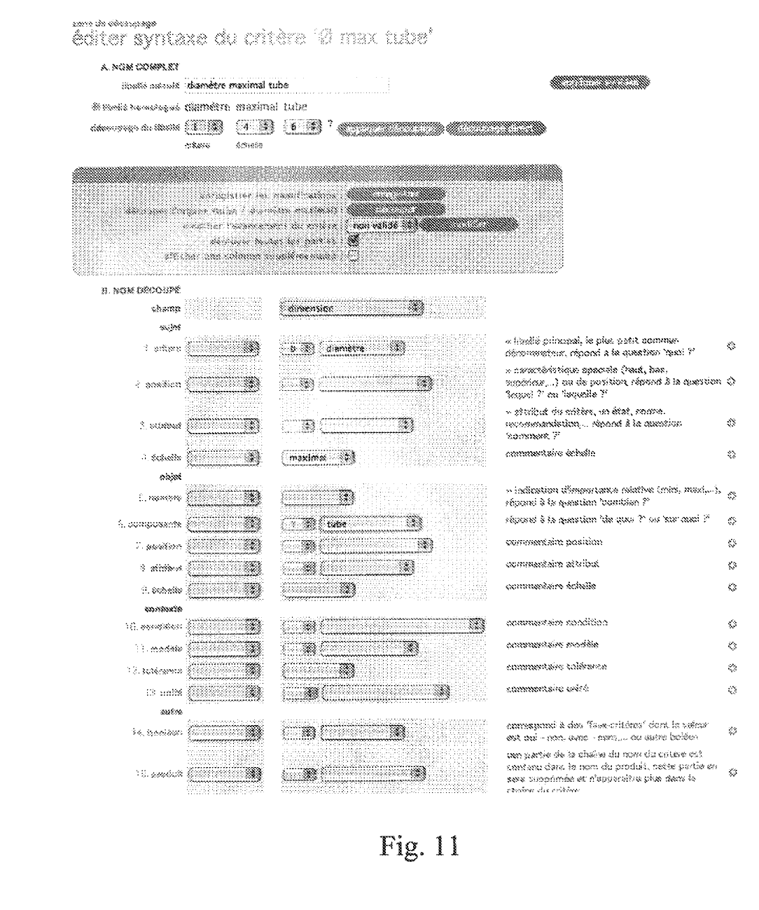

FIG. 11 shows a screen that contains the analysis and automatic breakdown of the ‘maximum-diameter tube’ line in 3 criteria: criterion+scale+component.

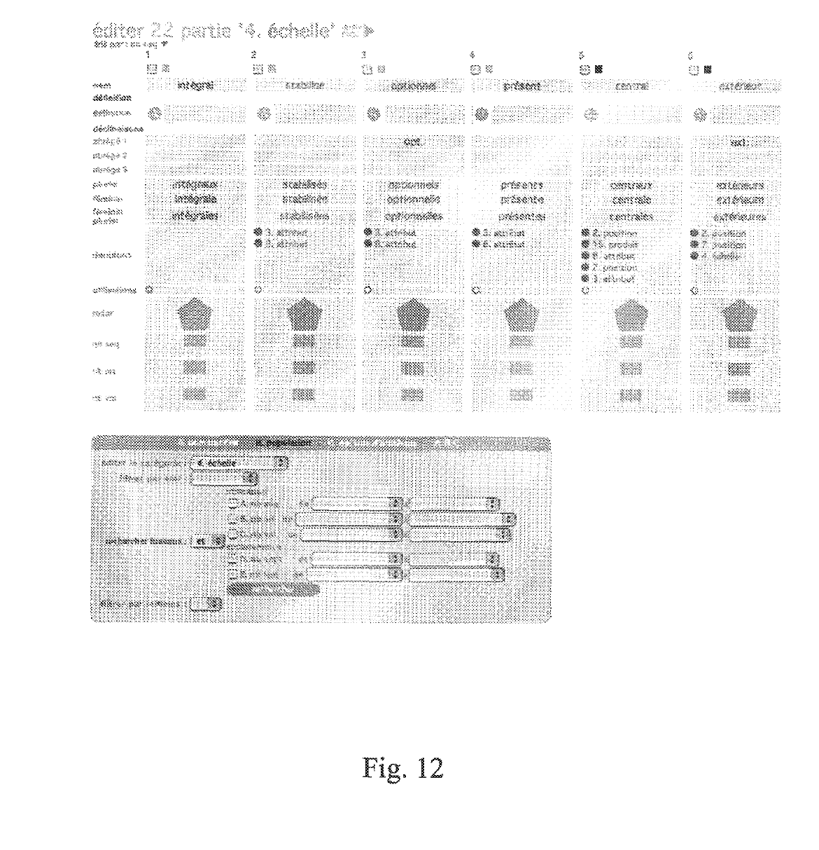

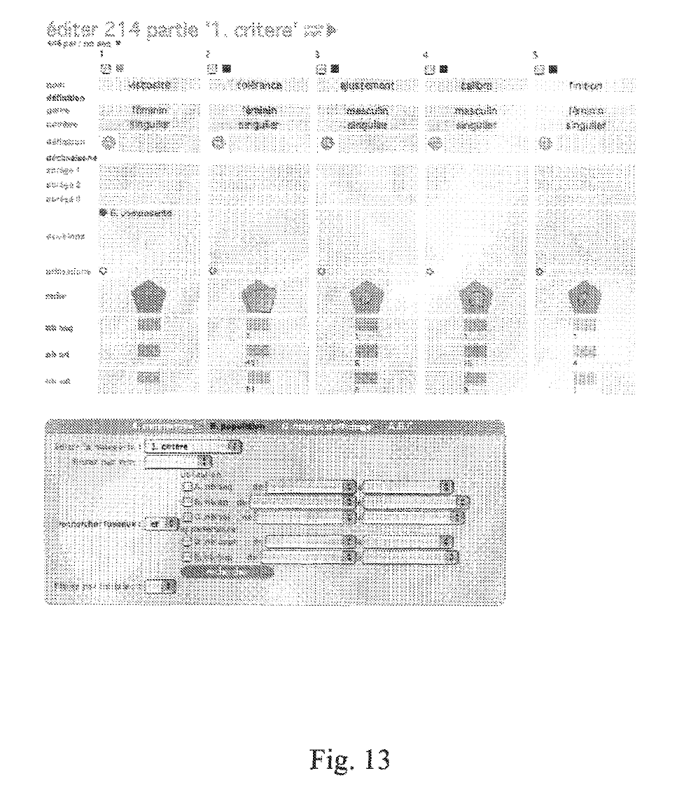

Each of these criteria is aggregated with its agreements of gender and number: feminine, plural, and its possible abbreviations, so as to be able to grant the criteria based on their context and so as to translate them and to propose all of the possible combinations of criteria in all of the languages (see FIGS. 12 and 13).

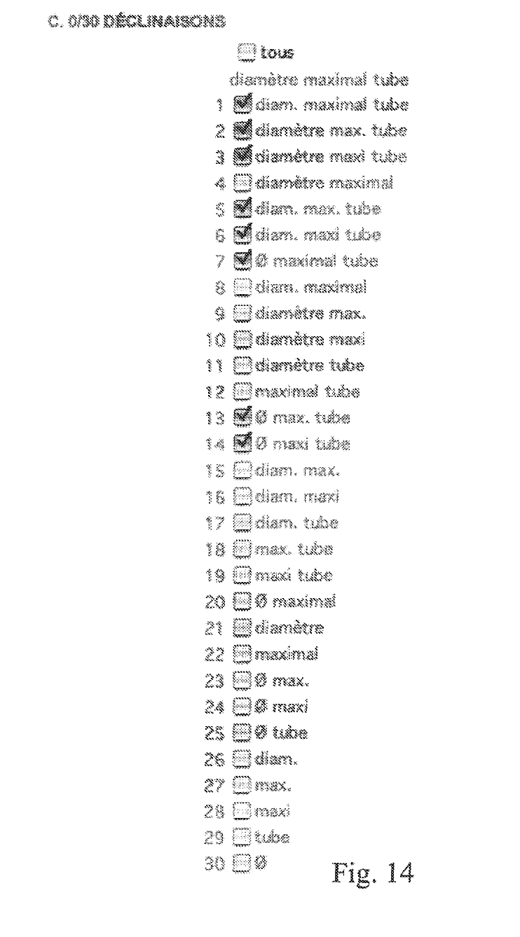

Each criterion is declined in recognized and authorized abbreviations (see FIG. 14).

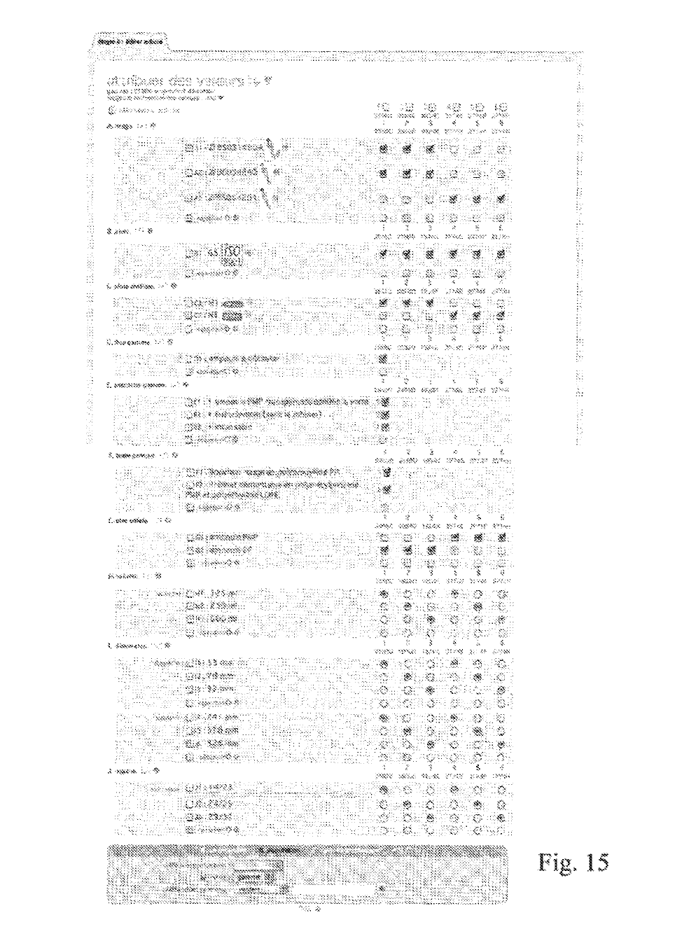

FIG. 15 shows an interface that forms a tool that makes it possible to acquire data in a list of criteria proposed for the writing of the contents. To this image, the author already added contents in the criteria that were proposed to him; he can add to it others via the line ‘to add’; the boxes to be checked on the right make it possible to distribute the values to different articles.

By way of example of upper structuring levels of the articles, it is possible to cite: department, family, subfamily, assortment and product.

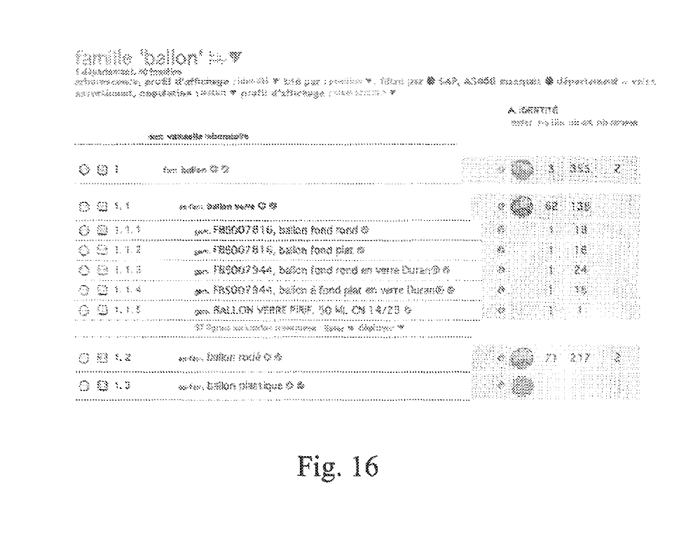

As FIG. 16 illustrates, the ‘flask’ family is found in a ‘laboratory vessel’ department and contains subfamilies: ‘glass flask,’ ground flask, ‘plastic flask’; the glass flask contains assortments: ‘round bottom,’ . . . ‘flat bottom’, . . . .

Thus, the invention makes it possible to generate automatic layouts and, in a first step, to select the best layouts based on different criteria for placing the surfaces, then in a second step, to meter the contents and the layouts of the latter based on reading practices for each reader.

To do this, the system according to the invention generates versions that answer the formatting rules and selects from among the latter the best version possible based on selection rules making it possible to evaluate them and to classify them according to a certain order of interest from multiple results that are obtained from the combination of x contents, y forms and z positions.

The rules that are used seek to adapt as well as possible the formatting to the content and vice-versa.

The rules for selection of the best proposal(s) are based on filling parameters (it is necessary that the blocks go into the page), size (that the image and text elements are as large as possible within the limit of their intrinsic quality—the body of a descriptive text is limited in size) and reading speed or readability (arrangement of the blocks based on their optical contrast, maximum visual distance of the different contrast points).

The basic principles of the rules applied by the process and the system are known by the graphic designers and are evident in particular from the following works:
Johannes ITTEN, “Art de la couleur,” Dessain et Tolra, 1961, Otto Maier Verlag;
François Richaudeau, “La lisibilité,” Paris, Retz, 1969-1976.

The rules are conditioned by the eye movement simulator that makes it possible to calculate the most likely reading speed and the user test that makes it possible to modify certain coefficients of said simulator for each of the users (based on the culture, age, available time, . . . ).

Of course, the invention is not limited to the embodiment that is described and shown in the accompanying drawings. Modifications are possible, in particular from the standpoint of the composition of various elements or by substitution of equivalent techniques, without thereby exceeding the field of protection of the invention.

1. Process for production and/or automatic conversion from complex and heterogeneous contents and by assembling blocks of information contents of the text, table and/or image type, from at least one visual composition of (a) page(s) allowing the fastest read with maximum retention, in particular for a reader or user or a specific group of readers or users, a process that is characterized in that it essentially consists in carrying out successively, at the level of a computer system, the following operations or working steps for each page:
a) Definition, in particular by analysis, factorization and defactorization, of the contents of blocks, from data input by the user or recovered from existing sources;
b) Application of programmed selective filtering rules, suitable for each type of content, and, if necessary, parameterized based on the user or the group of users, with different presentations proposed for the contents in the blocks;
c) Automatic generation and first selection of forms for the different blocks adopted following step b);
d) Application of programmed selective filtering rules, and, if necessary, parameterized based on the user or the group of users, with different proposals for block forms provided in step c);
e) Automatic generation and first selection of positioning options for different blocks adopted following step d);
f) Application of programmed selective filtering rules and, if necessary, parameterized based on the user or the group of users, with different layout proposals or versions provided in step e);
g) Presentation to the user or to the group of users of a formatted page mock-up version or proposal or several formatted page mock-up versions or proposals, whereby said proposals or versions are then classified according to a determined order of preference.

2. Process according to claim 1, wherein the successive operations a) to g) are arranged in three iterative loops for simulation and selection of the best proposals or versions of the forms of contents, forms of blocks and relative positioning options of the blocks on the page in question.

3. Process according to claim 1, wherein the operation a) for defining the contents of blocks and the operations for first selection at steps c) and e) implement integrated parameterization rules that carry out, on the one hand, a rejection of the proposals that are not in accordance with criteria or parameters based on presentation or resulting in an impossibility of presentation on the page in question, and, on the other hand, an evaluation and an assignment of proposals that are not rejected.

4. Process according to claim 1, wherein the operations a) and c) are executed in a differentiated manner based on the nature of the content of the processed blocks, namely text, image or table, and by applying a set of rules for formatting or specific parameterization respectively with each type of content, the operation e) that carries out the assembly of the different blocks of a page applies a set of rules common to the three types of blocks.

5. Process according to claim 1, wherein the visible total surface area of a block or a group of blocks is determined by reporting rules between the quantity of information contained in this or these blocks and the performance level that is expected for this information.

6. Process according to claim 1, wherein the positioning of the blocks in step e) is governed by rules for separating and combining blocks and by rules of maximum and minimum distances between separate blocks.

7. Process according to claim 1, wherein at least the filtering rules that are used before the operation g), preferably all of the filtering rules that are applied in the working steps b), d) and f), integrate rules that govern the travel of the human eye and the perception of contents during reading applied to the different proposals that are obtained from the preceding operation, whereby the latter are subjected in particular to an analysis of contrasts, forms and/or block positions with different contents that form each page.

8. Process according to claim 7, wherein it consists in measuring and recording the values of visual density or typographic grayscale of different content blocks, such as text, table or image, in determining and recording the contrasts between the visual densities or topographical grayscale of the different blocks, and in carrying out the positioning of the blocks so as to attribute the best contrasts and the best locations to the blocks whose contents are to be shown, in particular to be seen when a reader's eye glances rapidly over the page in question.

9. Process according to claim 7, wherein the selective filtering rules integrate selection criteria based on the optimum surface or size for each block, the optimum number of blocks per page, the filling rate of each page, and the number of movements of the eye to travel over each page, whereby said filtering rules are applied after each of the operations a), c) and e) or only after the operation e), whereby the proposals that are adopted after each filtering operation are protected.

10. Process according to claim 1, wherein the integrated rules that govern the first selections at the level of operations c) and e) and/or the filtering rules of the filtering operations b), d) and f) take into consideration information from available or estimated reading time, programmed, measured or estimated interest centers of the reader or group of readers, and the quantity of information to be recorded by the reader or group of readers in the available reading time.

11. Process according to claim 1, wherein it comprises a preliminary phase for learning preferences and special reading features of each reader or group of readers, for example by display of several compositions for testing and acquiring and translating comments and/or selections of the user or the group of users in question, in the form of preferences in terms of values or ranges of values of density, contrast, arrangement, size and chrominance by said reader or group.

12. Process according to claim 1, wherein it comprises an adjustment of the selective filtering rules of the working steps b), d) and f) based on the degree of satisfaction of the reader or group of readers with the proposal(s) for mock-up of (a) formatted page(s) and, if necessary, the arrangement of the latter, at the end of the operation g), whereby said adjustment is preferably carried out automatically by an evaluation of the proposal(s) accepted and/or rejected by the reader or group of readers and resulting in a variation of the gradation and/or the importance of each of the selective filtering rules that are applied.

13. Process according to claim 1, wherein the data processing for executing operations a) to g) is carried out in parallel by distribution of the computation loads over several computer units that are connected to one another, locally or in a network.

14. Process according to claim 1, wherein when the contents of at least certain text and/or table blocks are entered manually, one or more dynamic acquisition form(s) containing the criteria selected for the subject is (are) proposed to the user, author of the content on the subject, whereby the accessible existing contents relate to the subject that is processed by the user, and the similarities and differences detected after analysis and comparison are presented to the user upon request.

15. Process according to claim 1, wherein when the contents of at least certain blocks are imported or recovered from an outside source, there is carried out, on the one hand, an automatic detection of the type of content, its structure, its breakdown and links between the possible pages, and, on the other hand, a new presentation of said contents according to a preliminary parameterization, imposed standard, or, depending on the reader, based on the degree of preservation of the original presentation and a possible processing of the information that is the subject of the content, for example by factorization, translation, categorization or synthesization.

16. Process according to claim 15, wherein during the recovery of content(s) from an outside source or a specific medium, it consists in carrying out an analysis of each content and its presentation, in seeking criteria possibly hidden in this content, and in applying defactorization and factorization operations to this content, before defining one or more proposals for presentation of said content, whereby the accessible existing contents relate to the subject processed by the user and the similarities and differences detected after analysis and comparison are presented to the user upon request.

17. Process according to claim 15, wherein during the recovery of contents from the Internet sites, it consists in carrying out a search using a search engine that is parameterized based on the desired content, in carrying out a filtering a priori of the sites that are found, for example, based on the effective existence of the site, the date of its last update, its structuring and/or its quality index, in making the connection with the selected site(s), in carrying out a second selection a posteriori of the accessed sites, for example based on the relevance or the richness of the contents, in navigating in the site(s) adopted and in the possible links that are present at the page level of said site(s), in recovering the relevant heterogeneous contents, in reconstituting a single assembled content, optionally synthesized, in analyzing the resulting content and in seeking the hidden criteria and ultimately in defactorizing and in factorizing said content.

18. Process according to claim 1, wherein it consists in carrying out one or more operations for adjusting the visual composition proposal that is ultimately adopted by the user following operation g).

19. Automatic converter for presentation of contents for the purpose of optimizing the reading speed and the assimilation of information by a specific reader or a group of readers, implementing the process according to claim 1, comprising at least one computer that is equipped with a memory, a database, an interface for communication with the user, and a means for connecting to and navigating the Worldwide Web (Internet), for example in the form of a server or an analog interface, a converter that is characterized in that it also comprises:
The different contents to be laid out, in the form of blocks or optionally combined into an article,
The rules on possible segmenting of the contents and information on possible spacing of the contents,
The information relative to the different breakdowns of the content into upper structuring levels of the articles, for example department, family, sub-family, assortment and product, and into lower structuring levels of the contents, for example, fields, criteria and attributes,
The different rules for parameterization of applicable forms to the contents and to blocks and possible positions of the blocks,
The different rules for selecting or filtering presentations of the contents and forms and positions of the blocks,
The rules that control the travel of the eye during reading,
Information relative to the available reading time and to the centers of interest of the reader or group of readers being considered,
A system for analysis of contrasts, forms and positions of the contents,
A system for learning preferences and particular reading features of each reader or each group of readers,
A system for evaluating the reader's satisfaction of the applied parameterization and selection rules.

20. Converter according to claim 19, wherein it comprises several computers that are connected in a network, locally or not, and a system for distributing the computation loads over said computers.
